(19) United States
(12) Patent Application Publication
(10) Pub. No.: US 2026/0093600 A1
(43) Pub. Date: Apr. 2, 2026

(54) SOFTWARE SUPPLY SYSTEM SCHEMA

(71) Applicant: Dell Products L.P., Round Rock, TX (US)

(72) Inventor: Mathew Perry Comeau, Warren, MA (US)

(21) Appl. No.: 18/899,629

(22) Filed: Sep. 27, 2024

(51) Int. Cl. G06F 11/36; G06F 8/60

(52) U.S. Cl. CPC G06F 11/3604; G06F 8/60

(57) ABSTRACT

A system that implements a software supply system schema (S4) abstract representation of a software supply system includes a S4 controller that is programmed to: obtain a S4 object, in response to obtaining S4 object, perform a behavioral verification of the S4 object on the software supply system using a S4 behavioral verification module, based on the behavioral verification, apply the compositions and load the permissions, dependencies, filters, and priorities of the S4 object to the software supply system, and implement the loaded permissions, dependencies, filters, and priorities on the software supply system using the plurality of external artifacts. The S4 object defines a state for the software supply system, and specifies the compositions, permissions, dependencies, filters, and priorities of the software supply system and for the plurality of external artifacts.

### BACKGROUND

Computing devices may be used for the process of providing services as software supply systems. Further, computing devices are servicing increasing demand for an everything-as-code (XaC) paradigm where aspects of a system are primarily defined by computing code.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1.1 shows a diagram of a system in accordance with one or more embodiments of the invention.

FIG. 1.2 shows a diagram of a software supply system schema (S4) object in accordance with one or more embodiments of the invention.

FIG. 2 shows a flowchart for a method of realizing a S4 object on a software supply system in accordance with one or more embodiments of the invention.

FIG. 3 shows a diagram of a computer in accordance with one or more embodiments of the invention.

### DETAILED DESCRIPTION

Specific embodiments of the invention will now be described in detail with reference to the accompanying figures. In the following detailed description of the embodiments of the invention, numerous specific details are set forth in order to provide a more thorough understanding of one or more embodiments of the invention. However, it will be apparent to one of ordinary skill in the art that one or more embodiments of the invention may be practiced without these specific details. In other instances, well-known features have not been described in detail to avoid unnecessarily complicating the description.

In the following description of the figures, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

Throughout this application, elements of figures may be labeled as A to N. As used herein, the aforementioned labeling means that the element may include any number of items, and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure, and the number of elements of the second data structure, may be the same or different.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase ‘operatively connected’ may refer to any direct connection (e.g., wired directly between two devices or components) or indirect connection (e.g., wired and/or wireless connections between any number of devices or components connecting the operatively connected devices). Thus, any path through which information may travel may be considered an operative connection.

Embodiments disclosed herein include systems and methods for an abstract representation of a software supply system. A software supply system may be a system of software components, artifacts, compositions, and/or processes utilizing computing resources to provide services to users and/or to develop additional software components, artifacts, or compositions. The abstract representation of such software supply systems may be referred to as software supply system schema (S4).

In one or more embodiments, the S4 abstract representation of a software supply system is implemented using a S4 object that is realized using a S4 controller managing the software supply system. The S4 controller may include functionality to utilize the artifacts, compositions, and/or other software components to realize the S4 object. In this manner, the software supply system is represented using code so that it can be defined, realized, and verified with the same processes as other as-code computer systems. Said another way, S4 object may define the state of the software supply system, and the S4 controller may implement and enforce the defined state on the software supply system.

In one or more embodiments, a behavioral verification module is used to test and verify the implementation of the S4 object on the software supply system. For example, the behavioral verification is done in terms of the S4 object and from the perspective of the consumers (e.g., users) of the software supply system. With complete behavior verification, S4 users may verify functional equivalence of the S4 object on other software supply systems.

By providing S4 abstraction as defined throughout the present disclosure, a system may minimize any required configuration of its input sourcing tools. All the complexities (e.g., compositions, priorities, permissions, filters, protocols, etc.) for these artifacts and/or components may be represented in the system's S4 object. This representation may reference external artifacts, so one can define a software supply system with components defined elsewhere, based on, for example, a common infrastructure.

While specific details represented would vary across different software supply system providers and the types of inputs being supplied, the overall structure of an S4 representation remains consistent. The artifact delivery system directly used by the input-sourcing tools of a software supply system are represented at the top level of the S4 object. Each of these top-level objects may include the details required to describe the corresponding data used from artifacts, including any input-sourcing tools that are used to compose it, each of which would similarly contain their details and contributing sources (or references to them), and so on. A user may point their system (e.g., a software component, composition of artifacts or other components, etc.) at an endpoint of the software supply system, behind which is usually a complex system that may supply a variety of different artifacts that vary over time and are usually not explicitly represented in S4.

The following describes various embodiments of the invention.

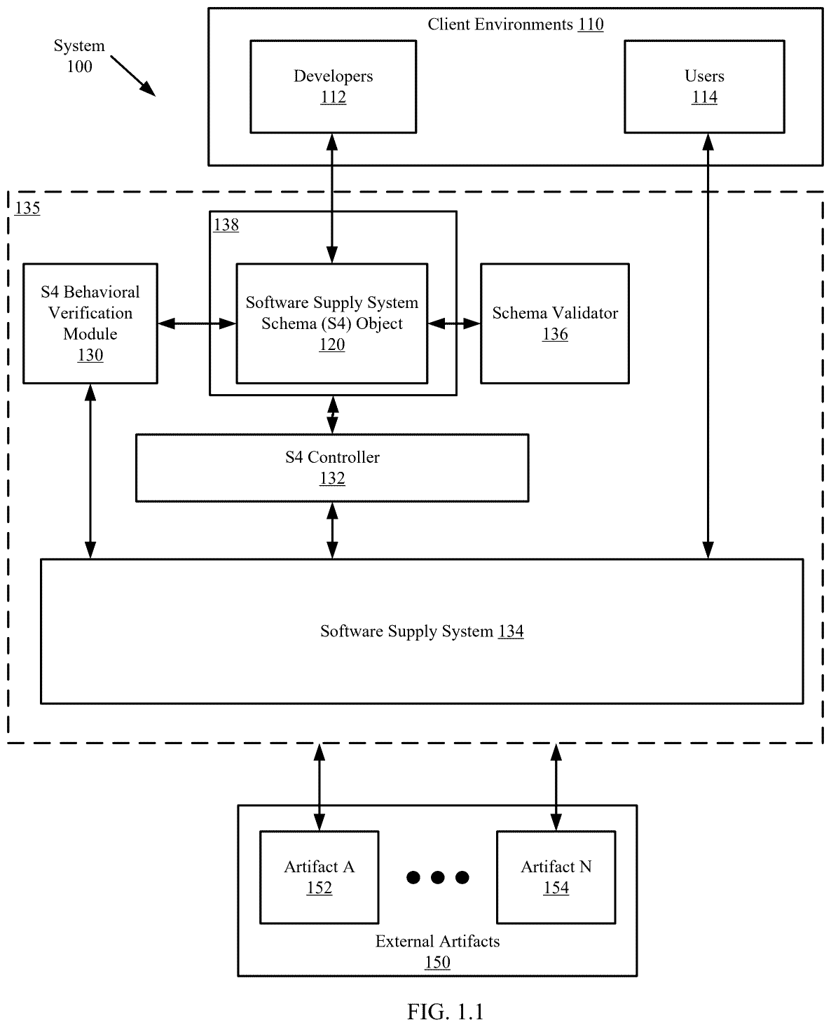

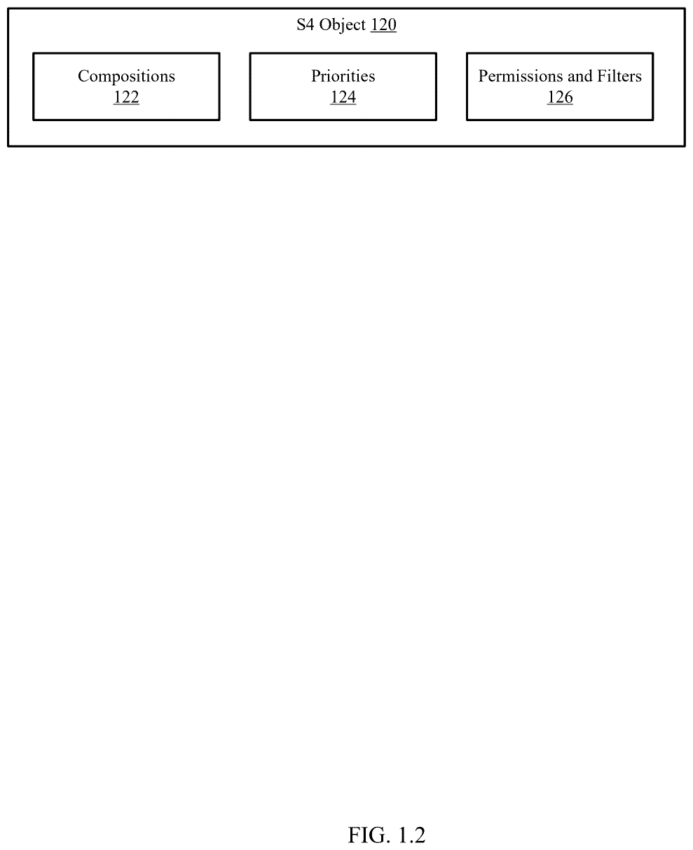

FIG. 1.1 shows a diagram of a system in accordance with one or more embodiments of the invention. The system (100) includes client environments (110) including developers (112) and users (114), any number of external artifacts (150), and a software supply system schema (S4) system (135). The S4 system (135) includes a S4 object (120) stored in a data store (138), a schema validator (136), a S4 behavioral verification module (130), a software supply system (120), and a S4 controller (132). The system (100) may include additional, fewer, and/or different components without departing from the invention.

In one or more embodiments, the S4 object (120) is a data structure that defines the compositions, priorities, permissions, filters, and/or other configurations that are used to abstractly represent the software supply system (134). Further, the S4 object (120) may be used to represent the software supply system (134) as a view of the ephemeral flow of components (such as software components, compositions, external artifacts (150), sources, etc.) in the software supply system (134) over time, both internal and external. The S4 object (120) may be defined by developers (112) of the S4 system (135) via any mechanisms, including, but not limited to: generation from a template that is used to create a specific instance of a best-practice pattern, manual definition generation, programmatic derivation or generation from an existing software supply system, and dynamic modification by a process that controls the access to restricted inputs for specific processes. The S4 object (120) may be validated by the schema validator (136) prior to being realized. The validating may include verifying the S4 object (120) is in an acceptable format in accordance with S4. Any formatting issues or warnings may be directed to the developers (112) for any remediation to the S4 object (120). In one or more embodiments, the validation may be performed prior to storing the S4 object (120) in the data store (138). For additional details regarding the S4 object, refer to FIG. 1.2.

In one or more embodiments, the software supply system (134) includes hardware components, software components, and/or other infrastructure for realizing a S4 object (120). The software supply system (134) may provide software supply system services such as packaged software, software pipelines, and/or other services without departing from the invention. The software supply system may be used to control the supply of software into an organization, the supply of internal software amongst the organization, and the supply of the internal software to other organizations. The software supply system (134) may utilize any number of components, compositions, artifacts (152, 154), or other software supply systems to realize the S4 object (120) and provide the software supply system services to users (114) operating in the client environments.

In one or more embodiments, the external artifacts (150) are software components accessible by the software supply system (134) for the realization of the S4 object (120) and/or components generated by the software supply system (134) usable by other entities. Each artifact (152, 154) may be implemented as, for example, a software package, downloadable source code, file systems and/or file system objects, an application container, and/or any other software component or source without departing from the invention. Each artifact (152, 154) may be accessible via any means or mechanisms including, but not limited to: a package manager, one or more application programming interfaces (API), source control tools, and file system managers that access file systems or file system objects in an artifact (152, 154).

In one or more embodiments, the software supply system (134) may be used to realize the S4 object (120) via any mechanisms including, but not limited to: dynamic provisioning of components of the software supply system (120) as defined by the S4 object (120) at the start of a continuous integration and continuous deployment (CI/CD) process, manual provisioning according to the S4 object (120), manual invocation of a process that consumes S4 inputs and creates the software supply system (134), and the use of the S4 controller (132) that works towards a desired state that is defined by the S4 object (120).

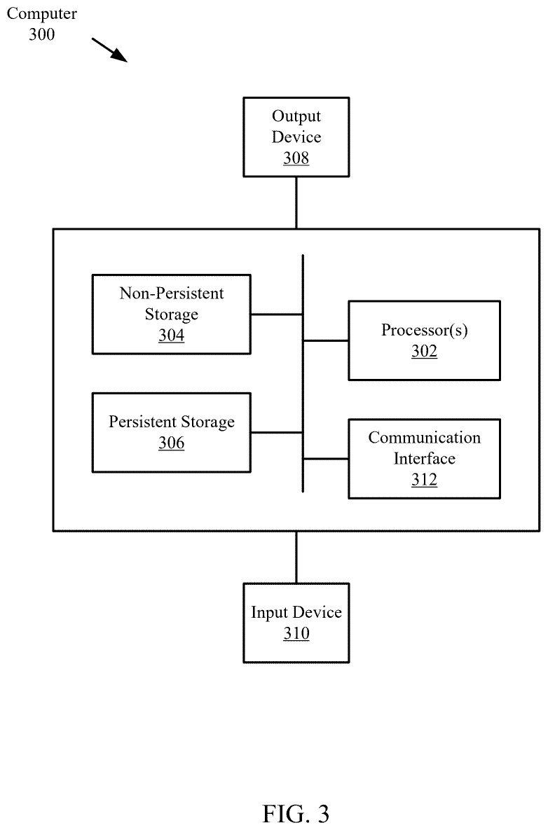

In one or more embodiments, the software supply system (134) is implemented as a computing device (e.g., 300, FIG. 3). A computing device may be, for example, a mobile phone, a tablet computer, a laptop computer, a desktop computer, a server, a sale terminal, a distributed computing system, or a cloud resource such as a transaction management unit. The computing device may include one or more processors, memory (e.g., RAM), and persistent storage (e.g., disk drives, SSDs, etc.). The computing device may include instructions, stored on the persistent storage, that when executed by the processor(s) of the computing device cause the computing device to perform the functionality of the software supply system (134) described throughout this present disclosure.

Alternatively, in one or more embodiments of the invention, the software supply system (134) is implemented as a logical device. A logical device may utilize the computing resources of any number of computing devices to provide the functionality of the software supply system (134) described throughout this present disclosure.

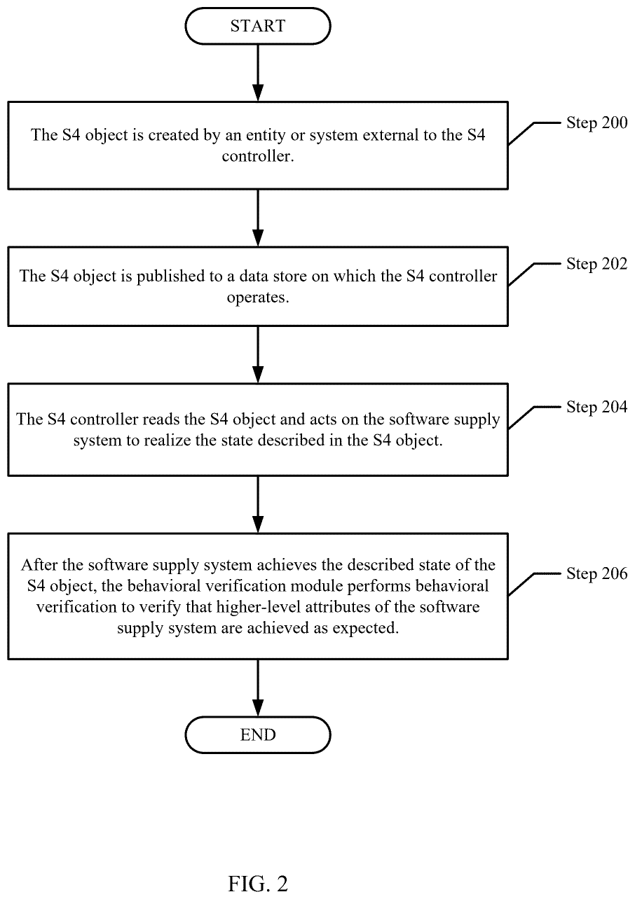

In one or more embodiments, the S4 object (120) is realized in the software supply system (134) using a S4 controller (132) in accordance with, for example, the methods of FIGS. 2, 3.1, and 3.2. Said another way, a state as described in the S4 object (120) is read by the S4 controller (132) and actions are performed on the software supply system (134) to realize the described state on the software supply system (134). The S4 object (120) is realized after updating the data store (138) to store the S4 object (120). The S4 controller (132) detects the storage of the S4 object (120) in the data store (138) to trigger the realization. The S4 object (120) may be realized in the software supply system (134) using other methods without departing from the invention. After the realization, the S4 controller (134) may utilize the S4 behavioral verification module (130) to monitor and verify the use of the source artifacts (150) by the software supply system (134) in accordance with the S4 object (120).

In one or more embodiments, the S4 controller (132) is implemented as a computing device (e.g., 300, FIG. 3). A computing device may be, for example, a mobile phone, a tablet computer, a laptop computer, a desktop computer, a server, a sale terminal, a distributed computing system, or a cloud resource such as a transaction management unit. The computing device may include one or more processors, memory (e.g., RAM), and persistent storage (e.g., disk drives, SSDs, etc.). The computing device may include instructions, stored on the persistent storage, that when executed by the processor(s) of the computing device cause the computing device to perform the functionality of the S4 controller (132) described throughout this present disclosure.

Alternatively, in one or more embodiments of the invention, the S4 controller (132) is implemented as a logical device. A logical device may utilize the computing resources of any number of computing devices to provide the functionality of the S4 controller (132) described throughout this present disclosure.

While the S4 object (120) is illustrated in FIG. 1.1 as a separate component of the S4 controller in the S4 system (135), the S4 object (120) may be stored in a data store of the S4 controller (134) or otherwise operated by the S4 controller (134).

In one or more embodiments, the S4 behavioral verification module (140) is implemented as a computing device (e.g., 300, FIG. 3). A computing device may be, for example, a mobile phone, a tablet computer, a laptop computer, a desktop computer, a server, a sale terminal, a distributed computing system, or a cloud resource such as a transaction management unit. The computing device may include one or more processors, memory (e.g., RAM), and persistent storage (e.g., disk drives, SSDs, etc.). The computing device may include instructions, stored on the persistent storage, that when executed by the processor(s) of the computing device cause the computing device to perform the functionality of the S4 behavioral verification module (140) described throughout this present disclosure.

Alternatively, in one or more embodiments of the invention, the S4 behavioral verification module (140) is implemented as a logical device. A logical device may utilize the computing resources of any number of computing devices to provide the functionality of the S4 behavioral verification module (140) described throughout this present disclosure.

In one or more embodiments, the client environments (110) may include any number of computing devices (refer to FIG. 3) operated by developers (112) and/or users (114). The developers (112) may refer to a subset of the users (114) that modify, generate, or otherwise create a S4 object (120) as described throughout the present disclosure. The users (114) may refer to entities that utilize, access, or otherwise interact with the software supply system (134) in accordance with the state described in the S4 object (120). The users (114) may, for example, consume input components or compositions of the software supply system (134), generate outputs used for the aforementioned components or compositions, access to compositions as defined by the S4 object (120), and perform other processes with the software supply system (134) without departing from the invention. The users (114) may be any entities that include, for example, people, organizations, automated processes (such as CI/CD systems), and/or any other types of entities without departing from the invention.

FIG. 1.2 shows a diagram of a S4 object in accordance with one or more embodiments of the invention. As discussed above, the S4 object (120) is a data structure that is used to define a software supply system (134). The S4 object (120) may include compositions (122), priorities (124), and permissions and filters (126). The S4 object may include additional, fewer, and/or different components without departing from the invention.

In one or more embodiments of the invention, the compositions (122) define the compositions of artifacts (or other components) of a software supply system (134, FIG. 1.1). For example, the compositions (122) may define how components in a software supply system interact, how each component is realized in the software supply system, an order or defined process in which artifacts (152, 154) are consumed in the software supply system, and/or any other processes for managing the compositions of artifacts in the software supply system.

In one or more embodiments, each of the compositions (122) defines a system of external artifacts, processes for consuming the artifacts (e.g., 150), other software supply systems, and/or other software components or sources that provide at least a portion of the software supply system services described throughout the present disclosure. The S4 object (120) may describe the compositions (122) as explicit or implicit use of any components (e.g., external artifacts (150, FIG. 1)) or other sources without departing from the invention.

In one or more embodiments, the priorities (124) define the priorities in which artifacts are to be used, the priorities in which entities (also referred to as users) of the software supply system may access the components, and other priorities without departing from the invention.

The specifics of the compositions (122) of the S4 object (120) may be used to appropriately reflect the real systems they represent. For example, one system may enforce resolution of artifacts as a list, another may use numerical priority where equivalent priorities are resolved at random. As such, S4 would represent these objects as unique types in a class hierarchy, each with the appropriate fields.

In one or more embodiments of the invention, the permissions and filters (126) define the entities accessing (or otherwise utilizing) the software supply system. For example, the permissions and filters (126) define, for each entity, which artifacts, or other components of the software supply system, are to be accessed by the given entity. Further, the permissions and filters (126) may define the policies for disallowing the flow of artifacts in any direction (e.g., input to the software supply system or output). Additionally, the permissions and filters (126) may define whether a user is allowed to deploy an artifact in a software component, composition, or other system of the software supply system. Examples of logical decisions made using the permissions include, but are not limited to, determining whether a user X is allowed to deploy on a system A of the software supply system and whether a user Y is allowed to overwrite an artifact in system B of the software supply system. Examples of policies used to filter the flow of artifacts in the software supply system include, but are not limited to, a name of an artifact matching a specific pattern, the value of an attribute of the artifact (e.g., a license), and the results of external processes such as evaluation of the artifact.

FIG. 2 shows a flowchart for a method of realizing a S4 object on a software supply system in accordance with one or more embodiments of the invention. The method shown in FIG. 2.1 may be performed by, for example, a S4 controller (e.g., 134, FIG. 1.1). Other components of the system in FIG. 1.1 or 1.2 may perform all, or a portion, of the method of FIG. 2 without departing from the invention.

While FIG. 2 is illustrated as a series of steps, any of the steps may be omitted, performed in a different order, additional steps may be included, and/or any or all of the steps may be performed in a parallel and/or partially overlapping manner with other steps in other methods without departing from the invention.

Turning to FIG. 2, in step 200, in step 200, the S4 object (e.g., 120, FIG. 1.1) is created by an entity (e.g., a person) or system external to the S4 controller. In one or more embodiments, the system may be a computing device operated by one or more developers (112, FIG. 1.1) discussed above.

In step 202, the S4 object is published to a data store on which the S4 controller operates. The data store may be, for example, a data store of the S4 controller (132, FIG. 1.1) as discussed above.

In step 204, the S4 controller reads the S4 object and acts on the software supply system to realize the state described in the S4 object. In one or more embodiments, the S4 object may be realized, either in part or in its entirety, via any means including, but not limited to: dynamic provisioning of the compositions, permissions, dependencies, filters, and priorities at the start of a CI/CD process, manual provisioning of the compositions, permissions, dependencies, filters, by the software supply system, and/or using the use of the S4 controller that operates to realize the described state of the S4 object. Said another way, the implementation and enforcement of the S4 object may be performed with any, all, or none of the automation capabilities that S4 enables. For example, one may use the S4 object as a centralized definition for the sake of clarity, or the S4 object be referenced to manually realize the described state, then be used to perform tests that verify the behavior of the software supply system in accordance with step 206 below.

In step 206, after the software supply system achieves the described state of the S4 object, the behavioral verification module performs behavioral verification to verify that higher-level attributes of the software supply system are achieved as expected. In one or more embodiments, the behavioral verification includes executes tests on attributes such as, for example: the compositions of software components to verify functionality, verify proper use of external artifacts, verify filtering policies specified in the S4 object, verify permissions defined in the S4 object, and verify operation of the computing resources to realize the defined software supply system defined by the S4 object. Other processes may be performed in the behavioral verification by the S4 controller, or any other software component of the software supply system, without departing from the invention.

Following the completion of the behavioral verification, the software supply system may be provided to the users for software supply system services as described throughout the present disclosure.

To clarify aspects of the invention described throughout the present disclosure, an example is described herein. Consider a scenario in which a product release, for whatever reason, requires use of a software package (e.g., an external artifact) that is disallowed across the entire organization. One way to leverage S4 to handle this is to associate the code change to the S4 object in that release's branch with an exception process approval. The excepted components are provisioned to a location that is, through the mechanisms defined in the S4 object (permissions, filters, new repos, etc.), accessible to only the build of the excepted product release. Following the change in code indicating this exception process approval, through a variety of techniques implemented by the S4 controller and specified in the updated S4 object, processes may realize and/or verify this special deployment of excepted components.

To clarify aspects of the invention described, an example is described herein. Consider a scenario in which an organization, in order to respond to a critical vulnerability discovered in an open-source software package, requires users to use an internally-patched version of this software package. The use of S4 may allow the organization to track the response as a code change to the S4 object and verify that the system correctly delivers the patched version of the software package using the behavioral verification. To ensure systems only use the appropriate artifacts, a S4 representation of the allowed input artifacts of a software supply system may be used to manage a network access policy, inspection of the configuration and policies applied to observed network traffic, or any other means to programmatically enforce the desired set of input artifacts.

As another example, consider a scenario in which a software supply system experiences a series of component failures that significantly degrade the operational ability of the software supply system. The component failures lead to vulnerabilities that are unresolved, which requires the use of a new software supply system. Embodiments disclosed herein enable S4 to provide such option. Specifically, given the compositions, priorities, permissions, filters, and components of the software supply system are defined using a S4 object. As such, a new, functionally equivalent, software supply system may be realized and validated in accordance with the S4 object and corresponding S4 controller and S4 behavioral verification module.

As discussed above, embodiments of the invention may be implemented using computing devices. FIG. 3 shows a diagram of a computing device in accordance with one or more embodiments of the invention. The computer (300) may include one or more computer processor(s) (302), non-persistent storage (304) (e.g., volatile memory, such as random access memory (RAM), cache memory), persistent storage (306) (e.g., a hard disk, an optical drive such as a compact disk (CD) drive or digital versatile disk (DVD) drive, a flash memory, etc.), a communication interface (312) (e.g., Bluetooth interface, infrared interface, network interface, optical interface, etc.), input devices (310), output devices (308), and numerous other elements (not shown) and functionalities. Each of these components is described below.

In one embodiment of the invention, the computer processor(s) (302) may be an integrated circuit for processing instructions. For example, the computer processor(s) may be one or more cores or micro-cores of a processor. The computer (300) may also include one or more input devices (310), such as a touchscreen, keyboard, mouse, microphone, touchpad, electronic pen, or any other type of input device. Further, the communication interface (312) may include an integrated circuit for connecting the computing device (300) to a network (not shown) (e.g., a local area network (LAN), a wide area network (WAN) such as the Internet, mobile network, or any other type of network) and/or to another device, such as another computing device.

In one embodiment of the invention, the computer (300) may include one or more output devices (308), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) (308, 310) may be locally or remotely connected to the computer processor(s) (302), non-persistent storage (304), and persistent storage (306). Many different types of computing devices exist, and the aforementioned input and output device(s) may take other forms.

Embodiments of the invention provide reliable and versatile representation of a software supply system. Relying on developers of software components or software supply systems to properly configure their artifacts is an example of client-side security. This client-side security may lead to high-profile dependency confusion attacks. The use of S4 in accordance with one or more embodiments of the invention enables a standardized representation for enforcement of these configurations within the software supply system using the more reliable and maintainable server-side approach to security.

In one or more embodiments, the software supply systems themselves may offer a way to programmatically configure and describe a software supply system using S4. Without S4, however, there is a prohibitive gap between the off-page references used by a system's input-sourcing tools and the state of the corresponding software supply systems. To achieve the use cases described throughout this disclosure, it may be required to consume and interpret a heterogeneous set of input-sourcing tool configurations, correlate these to extended configuration details (priority, composition, permissions, etc.), and attempt to achieve the various use cases with a combination of tool-configuration and interaction with the software supply systems. With S4, the input-sourcing tools may be minimally-configured and the complex behaviors and configurations can be moved to a homogenous, scalable, testable S4 abstract representation using a S4 object. The enablement of minimal configuration improves on the efficiency of utilizing computing resources for providing software supply system services to users.

Thus, embodiments of the invention may address the problem of inefficient use of computing resources in a computing environment. The problems discussed above should be understood as being examples of problems solved by embodiments of the invention of the invention and the invention should not be limited to solving the same/similar problems. The disclosed invention is broadly applicable to address a range of problems beyond those discussed herein.

One or more embodiments of the invention may be implemented using instructions executed by one or more processors of a computing device. Further, such instructions may correspond to computer readable instructions that are stored on one or more non-transitory computer readable mediums.

While the invention has been described above with respect to a limited number of embodiments, those skilled in the art, having the benefit of this disclosure, will appreciate that other embodiments can be devised which do not depart from the scope of the invention as of the invention. Accordingly, the scope of the invention should be limited only by the attached claims.

What is claimed is:

1. A system, comprising:
a software supply system schema (S4) controller comprising a processor;
a S4 object;
a S4 behavioral verification module; and
a software supply system, wherein the software supply system provides software services to users,
wherein the S4 controller is programmed to:
obtain the S4 object, wherein the S4 object defines a state for the software supply system, and wherein the S4 object comprises compositions, permissions, dependencies, filters, and priorities of the software supply system and for a plurality of external artifacts;
in response to obtaining the S4 object, apply the compositions and load the permissions, dependencies, filters, and priorities of the S4 object to the software supply system to realize the state;
after the software supply system achieves the state, perform a behavioral verification of the S4 object on the software supply system using the S4behavioral verification module; and
provide, using the software supply system in the state and using a plurality of external artifacts, software supply system services to a user.

2. The system of claim 1, wherein the S4 controller is further programmed to:
detect a change to the S4 object to obtain an updated S4 object;
in response to the change to the S4 object realize the updated S4 object on the software supply system; and
based on successful realization of the updated S4 object, perform a second behavioral verification of the updated S4 object on the software supply system.

3. The system of claim 2, wherein the change to the S4 object corresponds to accessing, by an entity using the software supply system, an artifact of the plurality of external artifacts.

4. The system of claim 2, wherein the change to the S4 object corresponds to deployment of a new artifact on the software supply system.

5. The system of claim 2, wherein the S4 object is generated by a developer of the software supply system, and wherein the change to the S4 object is generated by the developer.

6. The system of claim 1, further comprising:
a second software supply system,
wherein the S4 controller is further programmed to:
in response to obtaining S4, apply the compositions and load the permissions, dependencies, filters, and priorities of the S4 object to the second software supply system to realize the state;
after the second software supply system achieves the state, perform a second behavioral verification of the S4 object on the second software supply system using the S4 behavioral verification module; and
provide, using the second software supply system in the state, the software supply system services to the user.

7. The system of claim 1, wherein the plurality of external artifacts comprises at least one of: an application container, a binary software package, and a software source code.

8. A method for managing software supply systems, the method comprising:
obtaining an S4 object, wherein the S4 object defines a state for a software supply system, and wherein the S4 object comprises compositions, permissions, dependencies, filters, and priorities of a software supply system and for a plurality of external artifacts;
in response to obtaining the S4 object, applying the compositions and load the permissions, dependencies, filters, and priorities of the S4 object to the software supply system to realize the state;
after the software supply system achieves the state, performing a behavioral verification of the S4 object on the software supply system using a S4 behavioral verification module; and
providing, using the software supply system in the state and a plurality of external artifacts, software supply system services to a user.

9. The method of claim 8, further comprising:
detecting a change to the S4 object to obtain an updated S4 object;
in response to the change to the S4 object realizing the updated S4 object on the software supply system; and
based on successful realization of the updated S4 object, performing a second behavioral verification of the updated S4 object on the software supply system.

10. The method of claim 9, wherein the change to the S4 object corresponds to accessing, by an entity using the software supply system, an artifact of the plurality of external artifacts.

11. The method of claim 9, wherein the change to the S4 object corresponds to deployment of a new artifact on the software supply system.

12. The method of claim 9, wherein the S4 object is generated by a developer of the software supply system, and wherein the change to the S4 object is generated by the developer.

13. The method of claim 8, further comprising:
in response to obtaining the S4 object, applying the compositions and load the permissions, dependencies, filters, and priorities of the S4 object to a second software supply system to realize the state;
after the second software supply system achieves the state, performing a second behavioral verification of the S4 object on the second software supply system using the S4 behavioral verification module; and
providing, using the second software supply system in the state, software supply system services to the user.

14. The method of claim 8, wherein the plurality of external artifacts comprises at least one of: an application container, a binary software package, and a software source code.

15. A non-transitory computer readable medium comprising computer readable program code, which when executed by a computer processor enables the computer processor to perform a method for managing software supply systems, the method comprising:
obtaining an S4 object, wherein the S4 object defines a state for a software supply system, and wherein the S4 object comprises compositions, permissions, dependencies, filters, and priorities of a software supply system and for a plurality of external artifacts, wherein the plurality of external artifacts comprises at least one of: an application container, a binary software package, and a software source code;
in response to obtaining the S4 object, applying the compositions and load the permissions, dependencies, filters, and priorities of the S4 object to the software supply system to realize the state;
after the software supply system achieves the state, performing a behavioral verification of the S4 object on the software supply system using a S4 behavioral verification module; and
providing, using the software supply system in the state and using a plurality of external artifacts, software supply system services to a user.

16. The non-transitory computer readable medium of claim 15, further comprising:
detecting a change to the S4 object to obtain an updated S4 object;
in response to the change to the S4 object realizing the updated S4 object on the software supply system; and
based on successful realization of the updated S4 object, performing a second behavioral verification of the updated S4 object on the software supply system.

17. The non-transitory computer readable medium of claim 16, wherein the change to the S4 object corresponds to accessing, by an entity using the software supply system, an artifact of the plurality of external artifacts.

18. The non-transitory computer readable medium of claim 16, wherein the change to the S4 object corresponds to deployment of a new artifact on the software supply system.

19. The non-transitory computer readable medium of claim 16, wherein the S4 object is generated by a developer of the software supply system, and wherein the change to the S4 object is generated by the developer.

20. The non-transitory computer readable medium of claim 15, further comprising:
in response to obtaining the S4 object, applying the compositions and load the permissions, dependencies, filters, and priorities of the S4 object to a second software supply system to realize the state;
after the second software supply system achieves the state, performing a second behavioral verification of the S4 object on the second software supply system using the S4 behavioral verification module; and
providing, using the second software supply system in the state, software supply system services to the user.
